(19) United States
(12) Patent Application Publication
(10) Pub. No.: US 2006/0051687 A1
(43) Pub. Date: Mar. 9, 2006

(54) Inspection system and inspection method for pattern profile

(76) Inventors: Takema Ito, Yokohama-shi (JP); Hiroyuki Morinaga, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/218,623

(22) Filed: Sep. 6, 2005

(30) Foreign Application Priority Data
Sep. 7, 2004 (JP) P2005-260013

(51) Int. Cl. G06F 17/50; G03C 5/00

(52) U.S. Cl. 430/30; 716/19

(57) ABSTRACT

An inspection system includes a microscope configured to observe a mask pattern of a photomask and a projected image of the mask pattern on a substrate, a circuit data memory configured to store design data of a circuit pattern to be formed on the substrate by the mask pattern, a file generator configured to generate a coordinate file regarding the design data, the observed mask pattern, and the observed projected image, and an image interface configured to display same coordinates of the design data, the observed mask pattern, and the observed projected image based on the coordinates file.

### CROSS REFERENCE TO RELATED APPLICATIONS AND INCORPORATION BY REFERENCE

This application is based upon and claims the benefit of priority from prior Japanese Patent Application P2004-260013 filed on Sep. 7, 2004; the entire contents of which are incorporated by reference herein.

### BACKGROUND OF THE INVENTION

1. Field of the Invention

The present invention relates to design process for semiconductor device and in particular to an inspection system and an inspection method for pattern profile.

2. Description of the Related Art

A plurality of procedures such as a circuit design, a simulation of an optical proximity effect (OPE) degrading a pattern fidelity, an optical proximity correction to improve the pattern fidelity, manufacturing a photomask, and projecting mask patterns of the photomask onto a resist are included in a method for manufacturing a semiconductor integrated circuit. Therefore, it is important to inspect the difference between a designed circuit pattern and an actual circuit pattern after the semiconductor integrated circuit is manufactured. When the difference is significant and affects on a performance of the semiconductor integrated circuit, it is important to locate which process generates such difference. In Japanese Patent Laid-Open Publication No. 2002-351526, traceability database to trace back the plurality of procedures for manufacturing the semiconductor integrated circuit is constructed. The traceability database is provided to search trace log when the difference between the designed circuit pattern and the actual circuit pattern is found.

However, to recognize a change of the circuit pattern in the procedures, it is necessary to abstract the same coordinates from design data of the circuit pattern and image files of the actual circuit pattern observed in the procedures. But, such design data and image files usually have different pixels and may record different area of the semiconductor integrated circuit. Therefore, it has been difficult to abstract the same coordinates at the same time and elongated inspection time for the semiconductor integrated circuit.

### SUMMARY OF THE INVENTION

An aspect of present invention inheres in an inspection system according to an embodiment of the present invention. The system includes a microscope configured to observe a mask pattern of a photomask and a projected image of the mask pattern on a substrate, a circuit data memory configured to store design data of a circuit pattern to be formed on the substrate by the mask pattern, a file generator configured to generate a coordinate file regarding the design data, the observed mask pattern, and the observed projected image, and an image interface configured to display same coordinates of the design data, the observed mask pattern, and the observed projected image based on the coordinates file.

Another aspect of present invention inheres in an inspection method for pattern profile according to the embodiment of the present invention. The inspection method for pattern profile includes observing a mask pattern of a photomask and a projected image of the mask pattern on a substrate, obtaining design data of a circuit pattern to be formed on the substrate by the mask pattern, generating a coordinate file regarding the design data, the observed mask pattern, and the observed projected image, and displaying same coordinates of the design data, the observed mask pattern, and the observed projected image based on the coordinates file to inspect a difference among the design data, the observed mask pattern, and the observed projected image.

### BRIEF DESCRIPTION OF DRAWINGS

FIG. 1 is a diagram of an inspection system in accordance with an embodiment of the present invention;

FIG. 2 is a plan view of a photomask in accordance with the embodiment of the present invention;

FIG. 3 is an enlarged plan view of a circuit pattern in the photomask in accordance with the embodiment of the present invention;

FIG. 4 illustrates an exposure tool in accordance with the embodiment of the present invention;

FIG. 5 shows an example of a coordinates file in accordance with the embodiment of the present invention;

FIG. 6 illustrates first example of a display screen of the inspection system in accordance with the embodiment of the present invention;

FIG. 7 illustrates second example of the display screen of the inspection system in accordance with the embodiment of the present invention;

FIG. 8 illustrates third example of the display screen of the inspection system in accordance with the embodiment of the present invention;

FIG. 9 is a flowchart depicting an inspection method for a pattern profile in accordance with the embodiment of the present invention.

### DETAILED DESCRIPTION OF THE INVENTION

An embodiment of the present invention will be described with reference to the accompanying drawings. It is to be noted that the same or similar reference numerals are applied to the same or similar parts and elements throughout the drawings, and the description of the same or similar parts and elements will be omitted or simplified.

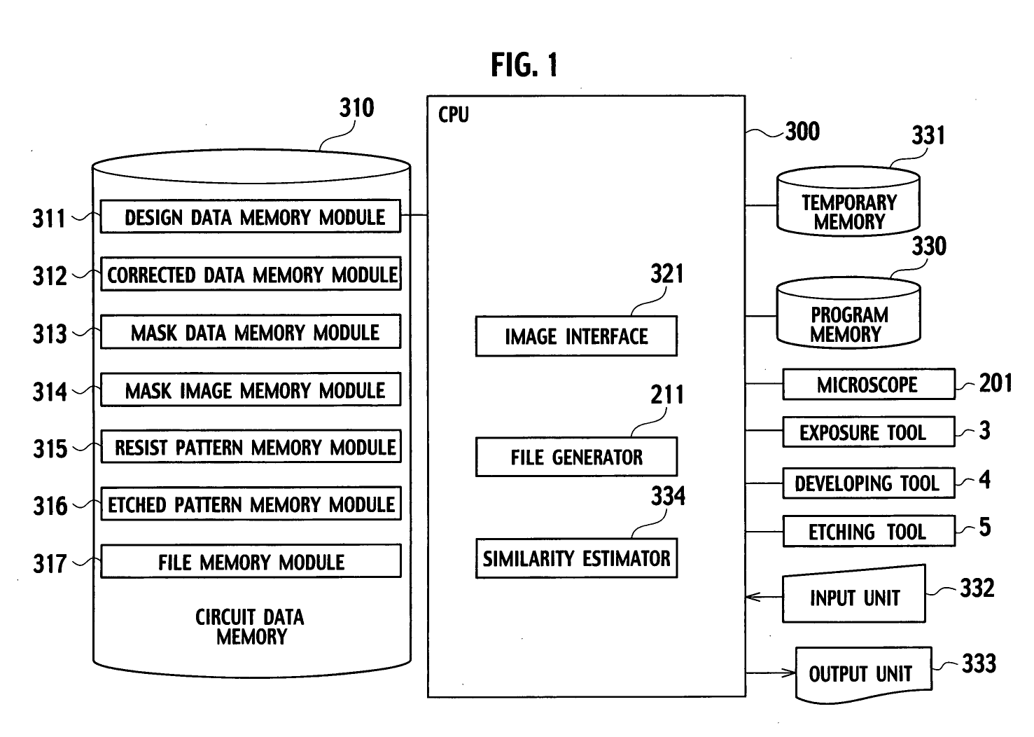

With reference to FIG. 1, an inspection system in accordance with an embodiment includes an exposure tool 3 and a microscope 201. The exposure tool 3 is configured to project a mask pattern of a photomask onto a resist coated on a semiconductor substrate. The mask pattern corresponds to a circuit pattern to be formed on the semiconductor substrate. The microscope 201 is configured to observe the mask pattern and a projected image of the mask pattern on the semiconductor substrate. The inspection system also includes a central processing unit (CPU) 300 and a circuit data memory 310 connected to the CPU 300. The circuit data memory 310 is configured to store design data of the circuit pattern. The CPU 300 includes a file generator 211 and an image interface 321. The file generator 211 is configured to generate a coordinates file regarding the design data, the observed mask pattern, and the observed projected image. The image interface 321 is configured to display the same coordinates of the designed data, the observed mask pattern, and the observed projected image.

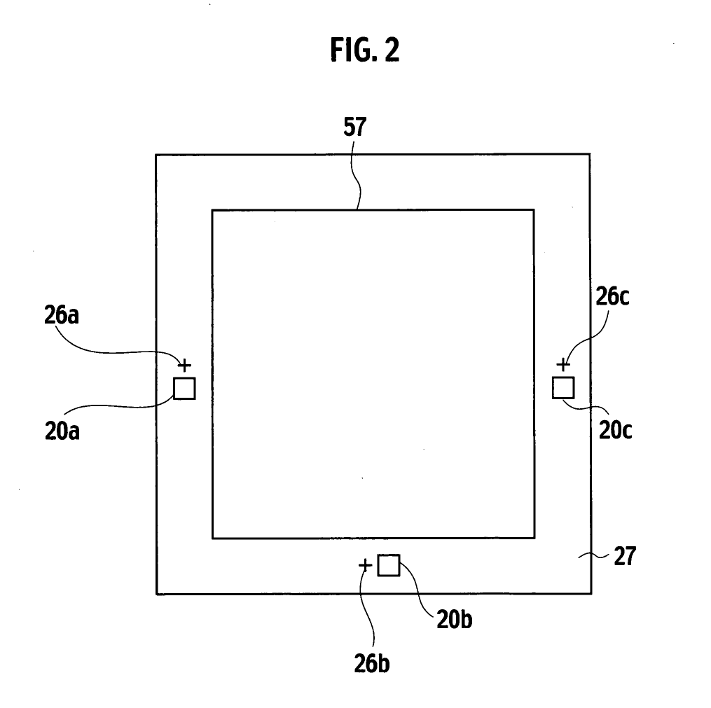

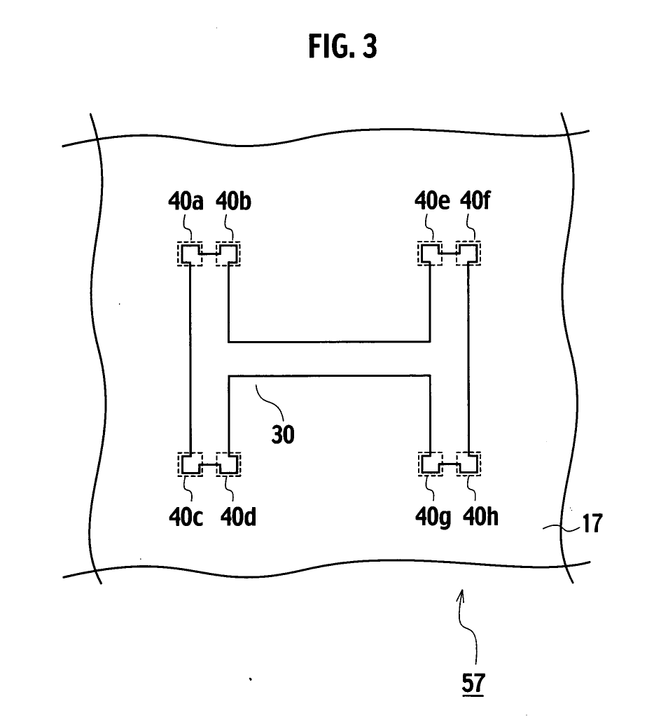

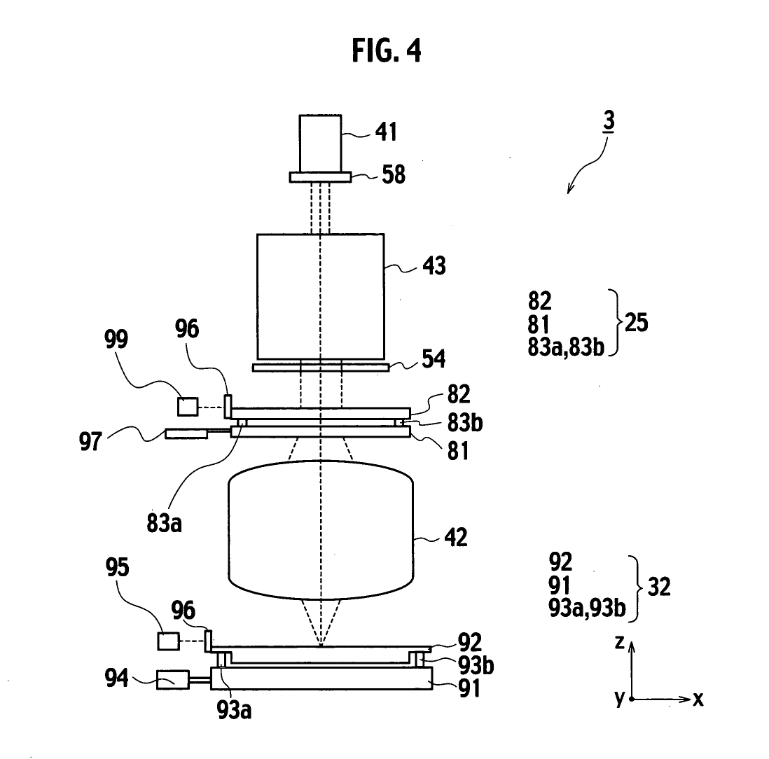

FIG. 2 shows an exampled photomask for manufacturing a semiconductor integrated circuit provided with the circuit pattern. The photomask includes a device pattern window 57 surrounded by a light shielding film 27. The device pattern window 57 contains a plurality of mask patterns. By projecting the plurality of mask patterns onto the resist, a semiconductor integrated circuit such as a SRAM, for example, is manufactured. As shown in FIG. 3, the device pattern window 57 contains the mask pattern 30. Serifs 40a, 40b, 40c, 40d, 40e, 40f, 40g, and 40h are added to the mask pattern 30 by an optical proximity correction (OPC) procedure. Each of the reference marks 20a, 20b, and 20c shown in FIG. 2 contains line and space patterns to quantify a manufacturing error. Alignment marks 26a, 26b, and 26c are delineated in the light shielding film 17. The alignment marks 26a-26c are used for the arrangement of the photomask on a reticle stage 25 in the exposure tool 3 shown in FIGS. 1 and 4.

With reference to FIG. 4, the exposure tool 3 includes a light source 41 emitting a light, an aperture diaphragm holder 58 disposed under the light source 41, an illuminator 43 condensing the light, a slit holder 54 disposed under the illuminator 43, a reticle stage 25 disposed beneath the slit holder 54, a projection optical system 42 disposed beneath the reticle stage 25, and a wafer stage 32 disposed beneath the projection optical system 42.

The photomask shown in FIG. 2 is disposed on the reticle stage 25. The reticle stage 25 shown in FIG. 4 includes a reticle XY stage 81, shafts 83a, 83b provided on the reticle XY stage 81, and a reticle tilting stage 82 attached to the reticle XY stage 81 through the shafts 83a, 83b. The reticle stage 25 is attached to a reticle stage aligner 97. The reticle stage aligner 97 aligns the position of the reticle XY stage 81. Each of the shafts 83a, 83b extends from the reticle XY stage 81. Therefore, the position of the reticle tilting stage 82 is determined by the reticle XY stage 81. The tilt angle of the reticle tilting stage 82 is determined by the shafts 83a, 83b. Further, a reticle stage mirror 98 is attached to the edge of the reticle tilting stage 82. The position of the reticle tilting stage 82 is monitored by an interferometer 99 disposed opposite the reticle stage mirror 98.

The semiconductor substrate coated with the resist is disposed on the wafer stage 32. The wafer stage 32 includes a wafer XY stage 91, shafts 93a, 93b provided on the wafer XY stage 91, and a wafer tilting stage 92 attached to the wafer XY stage 91 through the shafts 93a, 93b. The wafer stage 32 is attached to a wafer stage aligner 94. The wafer stage aligner 94 aligns the position of the wafer XY stage 91. Each of the shafts 93a, 93b extends from the wafer XY stage 91. Therefore, the position of the wafer tilting stage 92 is determined by the wafer XY stage 91. The tilt angle of the wafer tilting stage 92 is determined by the shafts 93a, 93b. Further, a wafer stage mirror 96 is attached to the edge of the wafer tilting stage 92. The position of the wafer tilting stage 92 is monitored by an interferometer 95 disposed opposite the wafer stage mirror 96.

With reference again to FIG. 1, a developing tool 4 develops the resist on which the mask pattern 30, shown in FIG. 3, is projected to form a resist pattern on the semiconductor substrate. Developing conditions including the concentration of a developer, a developer temperature, and a developing time are controlled by the CPU 300. An etching tool 5, shown in FIG. 1, selectively etches the semiconductor substrate or an insulator film covered with the resist pattern. The microscope 201 observes the mask pattern 30 in the photomask, shown in FIGS. 2 and 3. Also, the microscope 201 observes the resist pattern on the semiconductor substrate, etched patterns of the insulating film and the semiconductor substrate formed by using the resist pattern. An atomic force microscope (AFM) and a scanning electron microscope (SEM) can be used for the microscope 201.

With reference again to FIG. 1, the circuit data memory 310 contains a design data memory module 311, a corrected data memory module 312, a mask data memory module 313, a mask image memory module 314, a resist pattern memory module 315, an etched pattern memory module 316, and a file memory module 317. The design data memory module 311 stores the design data of the circuit pattern saved as an image file. The design data is generated by using a computer aided design (CAD) system, for example. The corrected data memory module 312 stores a simulated projected image. The simulated projected image is simulated by an optical simulation, based on the design data corrected by the OPC. The mask data memory module 313 stores a designed mask pattern saved as the image file. Manufacture of the photomask, shown in FIGS. 2 and 3, is based on the designed mask pattern. The mask image memory module 314 stores the observed mask pattern 30, saved as the image file. The resist pattern memory module 315 stores the observed resist pattern saved as the image file. The etched pattern memory module 316 stores the observed etched patterns of the semiconductor substrate or the insulator saved as the image file.

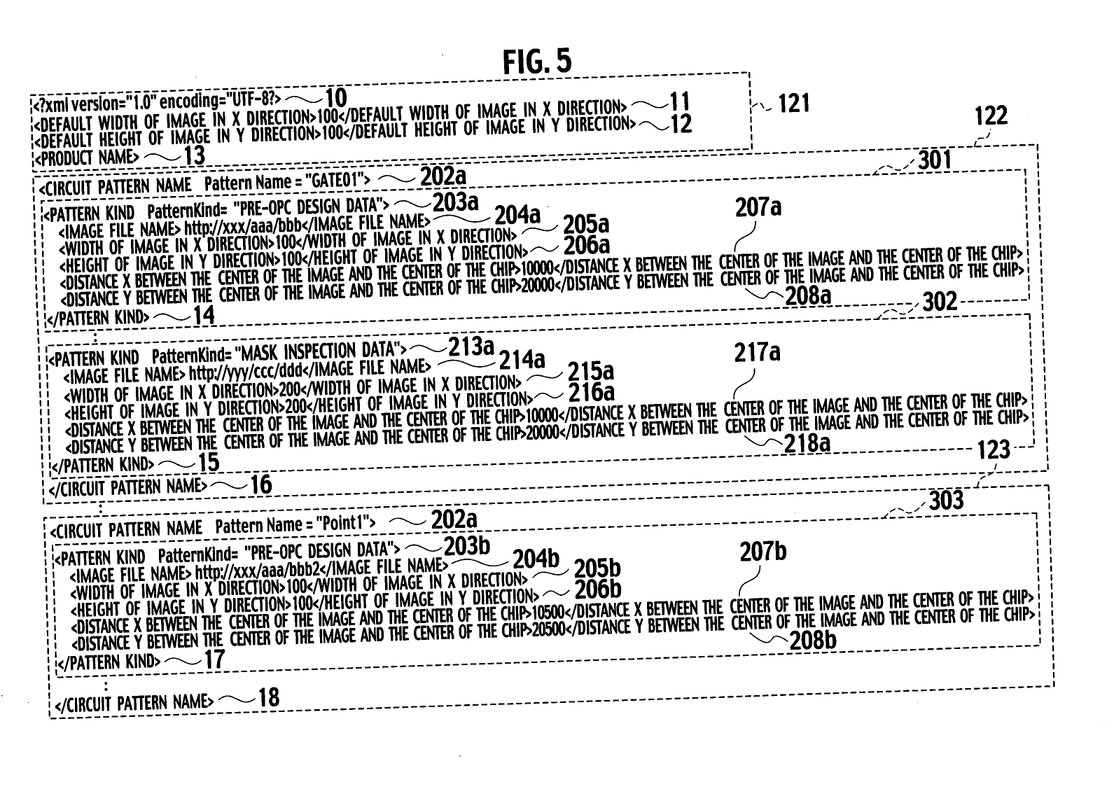

The exposure tool 3, the microscope 201, the developing tool 4, the etching tool 5, and the circuit data memory 310 are connected to the CPU 300. The file generator 211 in the CPU 300 reads the size of a region recorded in the image file of the design data. Also, the file generator 211 calculates a relative distance between the center of the region recorded in the image file of the design data and the center of the entire semiconductor integrated circuit. Also, the file generator 211 generates the coordinates file as shown in FIG. 5.

Further, the file generator 211 shown in FIG. 1 generates the coordinates file regarding the simulated projected image, the designed mask pattern, the observed mask pattern, the observed resist pattern, and the observed etched pattern.

The eXtensible Markup Language (XML) format is available for the coordinates file shown in FIG. 5, for example. The coordinates file contains a header section 121 and circuit pattern sections 122, 123. The header section 121 contains a document type declaration tag 10, a display width section 11, a display height section 12, and a product name tag 13. The document type declaration tag 10 specifies version information of the XML, for example. The display width section 11 specifies an initial value of a screen width in a lateral direction (X-direction) of a display window in the output unit 333 shown in FIG. 1. The display height section 12 specifies an initial value of a screen height in a vertical direction (Y-direction) of the display window in the output unit 333. The product name tag 13 specifies the product name of the semiconductor integrated circuit to be manufactured.

The circuit pattern section 122 specifies image information on the image files of the design data, the simulated projected image, the designed mask pattern, the observed mask pattern, the observed resist pattern, and the observed etched pattern. A pattern name tag 202a in the circuit pattern section 122 specifies a name of the circuit pattern recorded in the image file. In FIG. 5, the pattern name tag 202a specifies “GATE01” as the name of the circuit pattern. As an example, the circuit pattern section 122 contains a design data section 301 and a photomask section 302. The design data section 301 specifies information on the image file of the design data. The photomask section 302 specifies information on the image file of the observed mask pattern.

The design data section 301 contains a file name section 204a, a width size section 205a, a vertical size section 206a, a relative lateral distance section 207a, and a relative vertical distance section 208a. The file name section 204a specifies an address of a server storing the image file of the design data. For example, the file name section 204a specifies the internet address of the design data memory module 311 shown in FIG. 1. The width size section 205a shown in FIG. 5 specifies the width size of the region recorded in the image file of the design data in the X-direction. The vertical size section 206a specifies the vertical size of the region recorded in the image file of the design data in the Y-direction. The relative lateral distance section 207a specifies a relative lateral distance between the center of the entire semiconductor integrated circuit and the center of the region recorded in the image file of the design data in the X-direction. The relative vertical distance section 208a specifies a relative vertical distance between the center of the entire semiconductor integrated circuit and the center of the region recorded in the image file of the design data in the Y-direction. The file name section 204a, the width size section 205a, the vertical size section 206a, the relative lateral distance section 207a, and the relative vertical distance section 208a are interposed between a start tag 203a and an end tag 14 in the design data section 301.

The photomask section 302 contains a file name section 214a, a width size section 215a, a vertical size section 216a, a relative lateral distance section 217a, and a relative lateral distance section 218a. The file name section 214a specifies an address of a server storing the image file of the observed mask pattern. For example, the file name section 214a specifies the internet address of the mask image memory module 314 shown in FIG. 1. The width size section 215a shown in FIG. 5 specifies the width size of the image file of the observed mask pattern in the X-direction. The vertical size section 216a specifies the vertical size of the image file of the observed mask pattern in the Y-direction. The relative lateral distance section 217a specifies a relative lateral distance between the center of the entire mask patterns delineated in the photomask and the center of the region recorded in the image file of the observed mask pattern in the X-direction. The relative vertical distance section 218a specifies a relative vertical distance between the center of the entire mask patterns delineated in the photomask and the center of the region recorded in the image file of the observed mask pattern in the Y-direction. The file name section 214a, the width size section 215a, the vertical size section 216a, the relative lateral distance section 217a, and the relative vertical distance section 218a are interposed between a start tag 213a and an end tag 15 in the photomask section 302. The end of the circuit pattern section 122 is marked by an end tag 16.

The circuit pattern section 123 specifies image information on the image file of the design data about the circuit pattern “Point 1” contained in the semiconductor integrated circuit. The “Point 1” is different from the “GATE 1” of which information is specified in the circuit pattern section 122. About the “Point 1”, the circuit pattern section 123 also specifies image information on the image files of the simulated projected image, the designed mask pattern, the observed mask pattern, the observed resist pattern, and the observed etched pattern.

A pattern name tag 202b in the circuit pattern section 123 specifies the name of the circuit pattern. In FIG. 5, the pattern name tag 202b specifies “Pointl” as the name of the circuit pattern. The design data section 303 contains a start tag 203b, a file name section 204b, a width size section 205b, a vertical size section 206b, a relative lateral distance section 207b, a relative vertical distance section 208b, and an end tag 17. The end of the coordinates file is marked by an end tag 18. The coordinates file generated by the file generator 211 is stored in the file memory module 317 shown in FIG. 1.

The image interface 321 receives an instruction to display the circuit pattern in the output unit 333. When the image interface 321 receives the instruction, the image interface 321 fetches the coordinates file from the file memory module 317. Further, the image interface 321 instructs the output unit 333 to display the circuit patterns recorded in the image files of the design data, the simulated projected image, the designed mask pattern, the observed mask pattern, the observed resist pattern, and the observed etched pattern at the same display size.

For example, if the image interface 321 is instructed to display the circuit pattern “GATE01”, the image interface 321 reads the display width section 11, the display height section 12, the width size section 205a, and the vertical size section 206a shown in FIG. 5 to display the circuit pattern recorded in the image file of the design data stored in the design data memory module 311. Here, the display width section 11 specifies 100 micrometers as the initial value of the screen width in the X-direction. Also, the display height section 12 specifies 100 micrometers as the initial value of the screen width in the Y-direction. The width size section 205a specifies 100 micrometers as the width size in the X-direction of the region recorded in the image file of the design data. The vertical size section 206a specifies 100 micrometers as the vertical size in the Y-direction of the region recorded in the image file of the design data. In this case, the image interface 321 shown in FIG. 1 calculates a first ratio of the number of pixels of the image file of the design data per unit length to the number of pixels of the display window in the output unit 333 per unit length. The image interface 321 instructs the output unit 333 to display the image file of the design data at a magnification of a value of the first ratio.

When the image interface 321 is instructed to display the mask pattern corresponding to the circuit pattern “GATE01” recorded in the image file of the observed mask pattern stored in the mask image memory module 314, the image interface 321 reads the display width section 11 shown in FIG. 5, the display height section 12, the width size section 215a, and the vertical size section 216a. Here, the width size section 215a specifies 200 micrometers as the width size in the X-direction of the region recorded in the image file of the observed mask pattern. The vertical size section 216a specifies 200 micrometers as the vertical size in the Y-direction of the region recorded in the image file of the observed mask pattern. Therefore, the image interface 321 cuts 100 square micrometers from the image file of the observed mask pattern since each of the display width section 11 and the display height section 12 specifies 100 micrometers as the screen size in the X and Y directions. The center coordinates of the 100 square micrometers is chosen to be same with the center coordinates of the image file of the design data, based on the relative lateral distance section 207a, the relative vertical distance section 208a, the relative lateral distance section 217a, and the relative lateral distance section 218a. Further, the image interface 321 shown in FIG. 1 calculates a second ratio of the number of pixels of the image file of 100 square micrometers per unit length to the number of pixels of the display window in the output unit 333 per unit length. The image interface 321 instructs the output unit 333 to display the image file of the observed mask pattern at a magnification of a value of the second ratio. Therefore, the circuit pattern and the mask pattern contained in the image files of the design data and the observed mask pattern are displayed at the same size. Also, the image interface 321 instructs the output unit 333 to display the image files of the simulated projected image, the designed mask pattern, the observed resist pattern, and the observed etched pattern at the same size, based on the coordinates file.

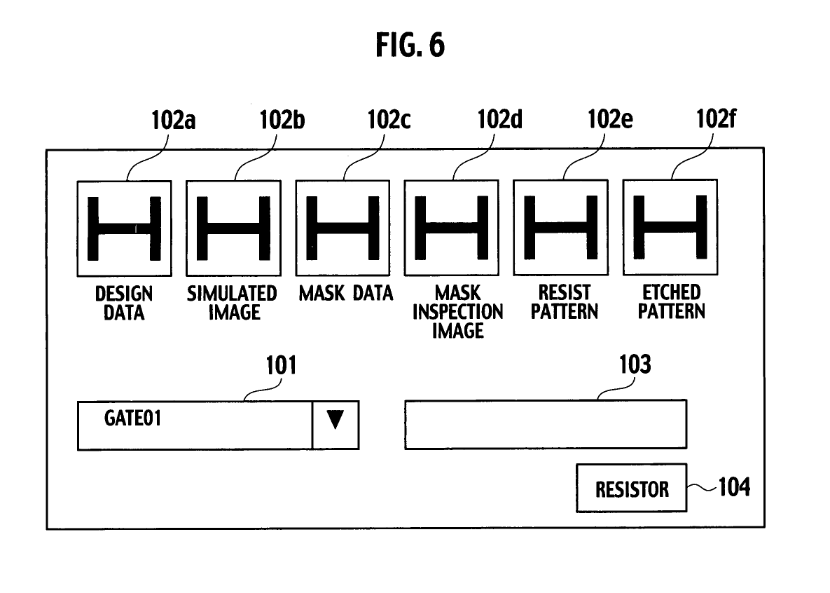

With reference to FIG. 6, a display screen of the output unit 333 contains a plurality of display windows 102a, 102b, 102c, 102d, 102e, and 102f. The display window 102a displays the image file of the design data. The display window 102b displays the image file of the simulated projected image. The display window 102c displays the image file of the designed mask pattern. The display window 102d displays the image file of the observed mask pattern. The display window 102e displays the image file of the observed resist pattern. The display window 102f displays the image file of the observed etched pattern. Also, the display screen of the output unit 333 contains a pull down menu 101, an input window 103, and an add registration button 104. The pull down menu 101 is used to choose the circuit pattern to be displayed. The input window 103 is used to enter a new registration name of the circuit pattern. The add registration button 104 is used to confirm the new registration name entered in the input window 103. In FIG. 6, the circuit pattern “GATE01” is chosen in the pull down menu 101.

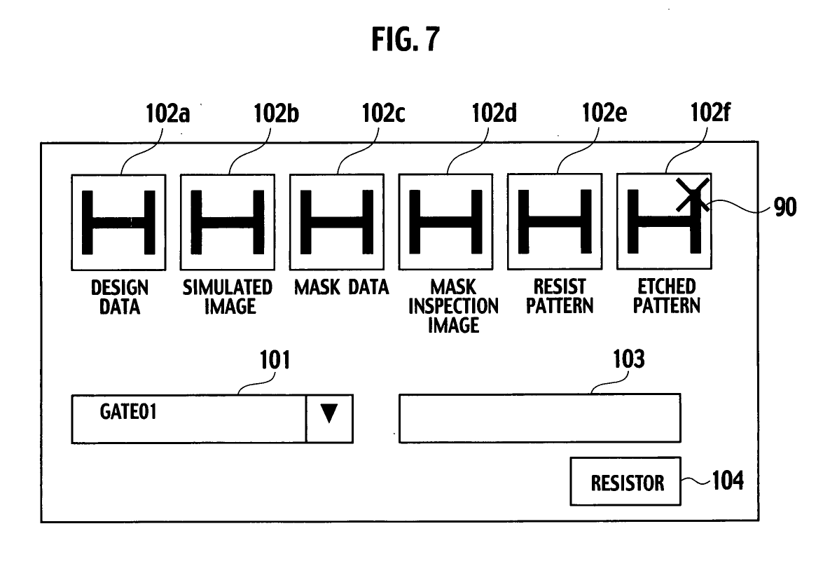

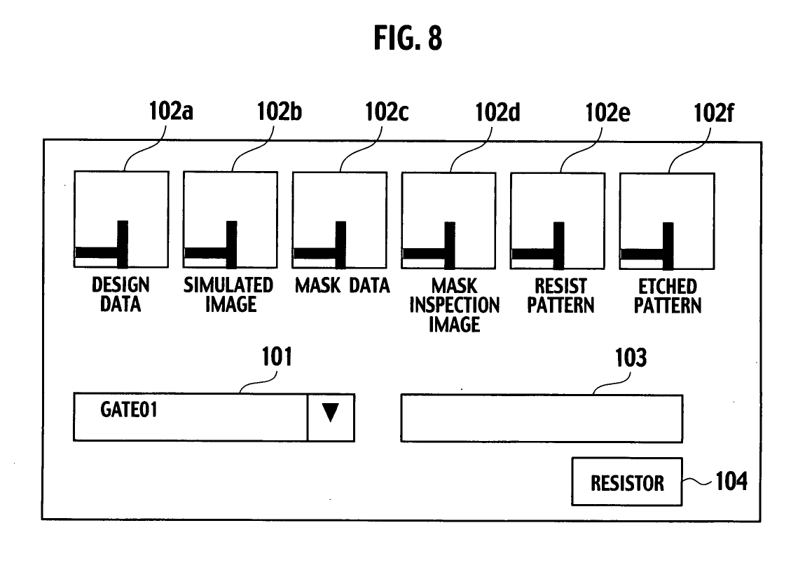

When an operator puts a pointer 90 on the display window 102f by using the input unit 323, such as the mouse, as shown in FIG. 7, the image interface 321 abstracts the center coordinates (xₒ, yₒ) of the display window 102f for the image file of the observed etched pattern and target coordinates (xₚ, yₚ) pointed by the pointer 90. Further, the image interface 321 calculates a displacement vector from the target coordinates (xₚ, yₚ) to the center coordinates (xₒ, yₒ). Also, the image interface 321 displaces all pixels of the image files displayed in the display windows 102a-102f by the displacement vector as shown in FIG. 8.

The CPU 300 shown in FIG. 1 further includes a similarity estimator 334. The similarity estimator 334 performs pattern matching between the image file of the design data displayed in the display window 102a and the image file of the simulated projected image displayed in the display window 102b. Based on a result of the pattern matching, the similarity estimator 334 estimates the similarity between the image file of the design data displayed in the display window 102a and the image file of the simulated projected image displayed in the display window 102b. If each of the display windows 102a, 102b has “x” pixels in the X-direction and “y” pixels in the Y-direction, height information at each pixel in the display window 102a is expressed as fₐ(x, y) for example. Also, height information at each pixel in the display window 102b is expressed as f_{b}(x, y) The similarity estimator 334 calculates the similarity “S_{ab}” by using an equation (1).

$${S}_{ab} = {\sum }_{x = 1}^{N} {\sum }_{y = 1}^{M} \vert {f}_{a} ( x , y ) - {f}_{b} ( x , y ) \vert \qquad ( 1 )$$

Also, the similarity estimator 334 calculates the similarity among the image files displayed in the display windows 102c-102f and the image file of the design data in the same way.

With reference again to FIG. 1, an input unit 332, an output unit 333, a program memory 330, and a temporary memory 331 are also connected to the CPU 300. A keyboard and a mouse may be used for the input unit 332. An LCD or an LED may be used for the output unit 333. The program memory 330 stores a program instructing the CPU 300 to transfer data with apparatuses connected to the CPU 300. The temporary memory 331 stores temporary data calculated during operation of the CPU 300.

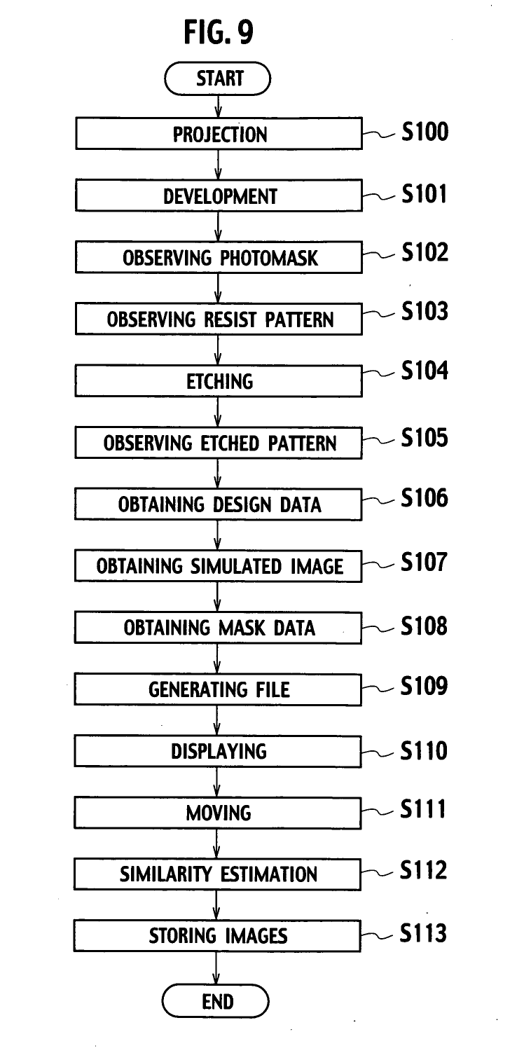

With reference to FIG. 9, an inspection method for pattern profile in accordance with the embodiment is described. The inspection method is performed by the inspection system shown in FIG. 1.

In step S100, the photomask, shown in FIG. 2, is displaced on the reticle stage 25 in the exposure tool 3 shown in FIGS. 1 and 4. Then, the semiconductor substrate coated with the resist is displaced on the wafer stage 32. Thereafter, the light source 41 emits the light and the mask pattern 30 delineated in the device pattern window 57, shown in FIG. 3, is projected onto the resist.

In step S101, the resist coated on the semiconductor substrate is developed with the developing tool 4 shown in FIG. 1. Consequently, the resist pattern is formed on the semiconductor substrate. In step S102, the mask pattern 30 in the device pattern window 57, shown in FIGS. 2 and 3, is observed by the microscope 201. The microscope 201 stores the image file of the observed mask pattern in the mask image memory module 314.

In step S103, the resist pattern on the semiconductor substrate is observed by the microscope 201. The microscope 201 stores the image file of the observed resist pattern in the resist pattern memory module 315. In step S104, the etching tool 5 selectively etches the semiconductor substrate or the insulator film on the semiconductor substrate by using the resist pattern as a chemical etchant mask. Consequently, the etched pattern of the semiconductor substrate or the insulator film on the semiconductor substrate is formed. In step S105, the etched pattern is observed by the microscope 201. The microscope 201 stores the image file of the observed etched pattern in the etched pattern memory module 316.

In step S106, the file generator 211 fetches the image file of the design data of the semiconductor integrated circuit stored in the design data memory module 311. The image file of the design data is stored in the design data memory module 311 beforehand. In step S107, the file generator 211 fetches the image file of the simulated projected image stored in the corrected data memory module 312. The image file of the simulated projected image is stored in the corrected data memory module 312 beforehand. In step S108, the file generator 211 fetches the image file of the designed mask pattern stored in the mask data memory module 313. The image file of the designed mask pattern is stored in the mask data memory module 313 beforehand.

In step S109, the file generator 211 shown in FIG. 1 fetches the image files of the observed mask pattern, the observed resist pattern, and the observed etched pattern from the mask image memory module 314, the resist pattern memory module 315, and the etched pattern memory module 316. Then, the file generator 211 reads the width sizes and the vertical sizes of the image files of the design data, the simulated projected image, the designed mask pattern, the observed mask pattern, the observed resist pattern, and the observed etched pattern. Then, the file generator 211 calculates the relative lateral distances and the relative vertical distances of the image files. Based on the width sizes, the vertical sizes, the relative lateral distances, and the relative vertical distances, the file generator 211 generates the coordinates file shown in FIG. 5.

In step S110, the image interface 321 shown in FIG. 1 instructs the output unit 333 to display the image files of the design data, the simulated projected image, the designed mask pattern, the observed mask pattern, the observed resist pattern, and the observed etched pattern at the same display size. The center coordinates of the displayed image files of the design data, the simulated projected image, the designed mask pattern, the observed mask pattern, the observed resist pattern, and the observed etched pattern are same. The center coordinates of the displayed image files are determined by the image interface 321, based on the relative lateral distance section 207a, 217a, and 207b, and the relative vertical distance section 208a, 218a, and 208b. As shown in FIG. 6, the patterns recorded in the image files corresponding to the same circuit pattern are displayed in the output unit 333.

In step S111, the pointer 90 is put on the target coordinates (xₚ, yₚ) in the display window 102f as shown in FIG. 7. Then, the image interface 321 shown in FIG. 1 calculates the displacement vector from the center coordinates (xₒ, yₒ) to the target coordinates (xₚ, yₚ). Thereafter, the image interface 321 displaces the image files on the display windows 102a-102f by the displacement vector as shown in FIG. 8.

In step S112, the similarity estimator 334 shown in FIG. 1 estimates the similarity between the image file of the design data displayed on the display window 102a and the image file of the simulated projected image displayed on the display window 102b. Also, the similarity estimator 334 estimates the similarity among the image file of the design data and the image files displayed on the display window 102c-102f. In step S113, the image interface 321 stores the displaced image files shown in FIG. 8 in the circuit data memory 310 and the method according to the embodiment is completed.

In an earlier method, the image files of the design data, the simulated projected image, the designed mask pattern, the observed mask pattern, the observed resist pattern, and the observed etched pattern are managed individually. Therefore, it has been difficult to view the same coordinates of the plurality of image files. Also, since there are limits of a scan rate and a resolution of the microscope 201 shown in FIG. 1, it is difficult to observe the entire photomask, the entire resist pattern, and the entire etched pattern. Therefore, portions of the photomask, the resist pattern, and the etched pattern are usually observed by the microscope 201. Accordingly, it has been difficult to search the same coordinates from the plurality of image file. However, the inspection system shown in FIG. 1 generates the coordinates file regarding the image files of the design data, the simulated projected image, the designed mask pattern, the observed mask pattern, the observed resist pattern, and the observed etched pattern. Therefore, by using the coordinates file, it is easy to view the same coordinates of the image files. Also, it is possible to evaluate the similarity among the image file of the design data and the image files of the observed resist pattern and the observed etched pattern in step S112. Therefore, the inspection system and method according to the embodiment make it possible to improve pattern fidelity.

### Other Embodiments

Although the invention has been described above by reference to the embodiment of the present invention, the present invention is not limited to the embodiment described above. Modifications and variations of the embodiment described above will occur to those skilled in the art, in the light of the above teachings. For example, there is no need to set the CPU 300 shown in FIG. 1, the circuit data memory 310, and the microscope 201 at the same place. Setting the CPU 300, the circuit data memory 310, and the microscope 201 at different places is available. Also, the display screen containing the pull down menu 101 to choose the circuit pattern is illustrated in FIGS. 6-8. However, sending the internet address specified in the file name section shown in FIG. 5 by using the input unit 332 to display the circuit pattern in the output unit 333 is available. As described above, the present invention includes many variations of embodiments. Therefore, the scope of the invention is defined with reference to the following claims.

What is claimed is:

1. An inspection system comprising:
a microscope configured to observe a mask pattern of a photomask and a projected image of the mask pattern on a substrate;
a circuit data memory configured to store design data of a circuit pattern to be formed on the substrate by the mask pattern;
a file generator configured to generate a coordinate file regarding the design data, the observed mask pattern, and the observed projected image; and
an image interface configured to display same coordinates of the design data, the observed mask pattern, and the observed projected image based on the coordinates file.

2. The system of claim 1, further comprising a similarity estimator configured to estimate a similarity among the design data, the observed mask pattern, and the observed projected image.

3. The system of claim 1, wherein the design data is corrected by an optical proximity correction.

4. The system of claim 1, wherein the image interface receives target coordinates in the design data.

5. The system of claim 4, wherein the image interface calculates a displacement vector from the target coordinates to center coordinates of the design data.

6. The system of claim 5, wherein the image interface displaces the design data by the displacement vector.

7. The system of claim 5, wherein the image interface displaces the observed mask pattern and the observed projected mask pattern by the displacement vector.

8. The system of claim 1, wherein the image interface receives target coordinates in the observed mask pattern.

9. The system of claim 8, wherein the image interface calculates a displacement vector from the target coordinates to center coordinates of the observed mask pattern.

10. The system of claim 9, wherein the image interface displaces the observed mask pattern by the displacement vector.

11. The system of claim 9, wherein the image interface displaces the design data and the observed projected mask pattern by the displacement vector.

12. The system of claim 1, wherein the image interface receives target coordinates in the observed projected image.

13. The system of claim 12, wherein the image interface calculates a displacement vector from the target coordinates to center coordinates of the observed projected pattern.

14. The system of claim 13, wherein the image interface displaces the observed projected image by the displacement vector.

15. The system of claim 13, wherein the image interface displaces the design data and the observed mask pattern by the displacement vector.

16. An inspection method for pattern profile including:
observing a mask pattern of a photomask and a projected image of the mask pattern on a substrate;
obtaining design data of a circuit pattern to be formed on the substrate by the mask pattern;
generating a coordinate file regarding the design data, the observed mask pattern, and the observed projected image; and
displaying same coordinates of the design data, the observed mask pattern, and the observed projected image based on the coordinates file to inspect a difference among the design data, the observed mask pattern, and the observed projected image.

17. The method of claim 16, further including estimating a similarity among the design data, the observed mask pattern, and the observed projected image.

18. The method of claim 16, further including:
defining target coordinates in the design data;
calculating a displacement vector from the target coordinates to center coordinates in the design data; and
displacing the design data, the observed mask pattern, and the observed projected image by the displacement vector.

19. The method of claim 16, further including:
defining target coordinates in the observed mask pattern;
calculating a displacement vector from the target coordinates to center coordinates in the observed mask pattern; and
displacing the design data, the observed mask pattern, and the observed projected image by the displacement vector.

20. The method of claim 16, further including:
defining target coordinates in the observed projected image;
calculating a displacement vector from the target coordinates to center coordinates in the observed projected image; and
displacing the design data, the observed mask pattern, and the observed projected image by the displacement vector.
